(19) United States
(12) Patent Application Publication
(10) Pub. No.: US 2002/0078583 A1
(43) Pub. Date: Jun. 27, 2002

(54) Picture hanging slide ruler

(76) Inventor: Vickie Richardson, Denison, TX (US)

Correspondence Address: Randal D. Homburg, 4th Floor, 50 Penn Place, Oklahoma City, OK, 73118-1803, US

(21) Appl. No.: 10/007,539

(22) Filed: Dec. 10, 2001

Related U.S. Application Data
(60) Provisional application No. 60/249,916, filed on Nov. 20, 2000.

(51) Int. Cl. G01D 21/00

(52) U.S. Cl. 33/613

(57) ABSTRACT

The invention is a picture hanging slide ruler for hanging items requiring two or more wall attachments upon walls in a level fashion and to enable the user to locate the proper measured spacing required between the applied wall attachments to conform the applied wall attachments to the exact required spacing between the multiple picture hanging attachments. The device is also applied to the hanging of shelves, sconces, shadow box displays, tapestries, blankets or other wall displayed items.

### CROSS REFERENCE TO RELATED APPLICATIONS

Provisional Patent Application, Serial No. 60/249,916 filed Nov. 20, 2000.

### I. BACKGROUND OF INVENTION

1. Field of the Invention

The invention is a picture hanging slide ruler for hanging items requiring two or more wall attachments upon walls in a level fashion and to enable the user to locate the proper measured spacing required between the applied wall attachments to conform the applied wall attachments to the exact required spacing between the multiple picture hanging attachments. The device is also applied to the hanging of shelves, sconces, shadowbox displays, tapestries, drapes, curtains, blankets or other wall displayed items.

2. Description of Prior Art

The following United States patents are identified and disclosed herein. Several devices are provided relating to picture hanging devices, none exhibiting the overall characteristics of the current invention. In U.S. Pat. No. 5,848,489 to Hartley, a built-in level is included in a picture frame. U.S. Pat. No. 5,802,729 to O'Brien, U.S. Pat. No. 5,634,279 to Ariyo, U.S. Pat. No. 4,944,094 to Depiano, and U.S. Pat. No. 4,212,123 to Robin are tools which rest upon a picture frame to indicate level placement, but does not include any element which provides locations for the direct placement of multiple wall attaching devices or nails. Conformable and bendable leveling devices for the placement of pictures in a level plane on curves surfaces and comers are disclosed in U.S. Pat. No. 5,560,116 to Tobia and U.S. Pat. No. 5,463,817 to Leeds.

### II. SUMMARY OF THE INVENTION

A number of items hung on a vertical planar surface require more than one point of attachment in order to be securely hung. Included are items such as shelves, sconces, tapestries, blankets, curtains, blanket holders and very large pictures and portraits. The primary objective of the current invention is to provide the invention having slidable ruled members with two or more wall attachment locating tabs having holes to mark the vertical planar surface upon which the hung item is to be displayed to insure that when the wall attachments are affixed to the planar surface, they are properly spaced and level. The invention includes a level means and two or more adjustable width wall attachment locating tabs having holes, to mark the appropriate location of the wall attachments prior to the insertion of the wall attachments to the vertical planar surface, preventing multiple misplacement of the wall attachments resulting in numerous unnecessary holes in the planar surface.

### III. DESCRIPTION OF THE DRAWINGS

The following drawings are drawings submitted with this utility patent application.

FIG. 1 is a close-up front view of the invention in a retracted fashion showing the ruled lines, the wall attachments locating tabs and the level means.

FIG. 2 is a distant front view of the invention in an extended fashion.

FIG. 3 is a perspective view of the invention as the appropriate spacing is determined on a shelf to be hung on a wall.

FIG. 4 is the invention, after having obtained the appropriate spacing, placed level against a wall indicating the location of the proper placement of the multiple wall attachments.

### IV. DESCRIPTION OF THE PREFERRED EMBODIMENT

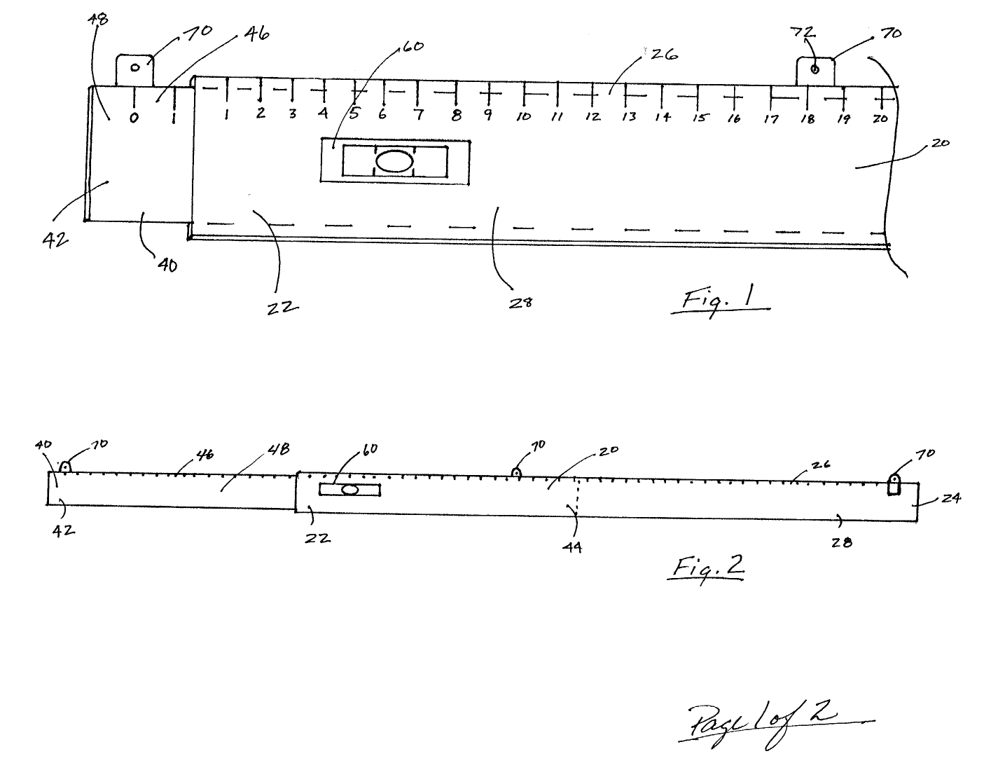

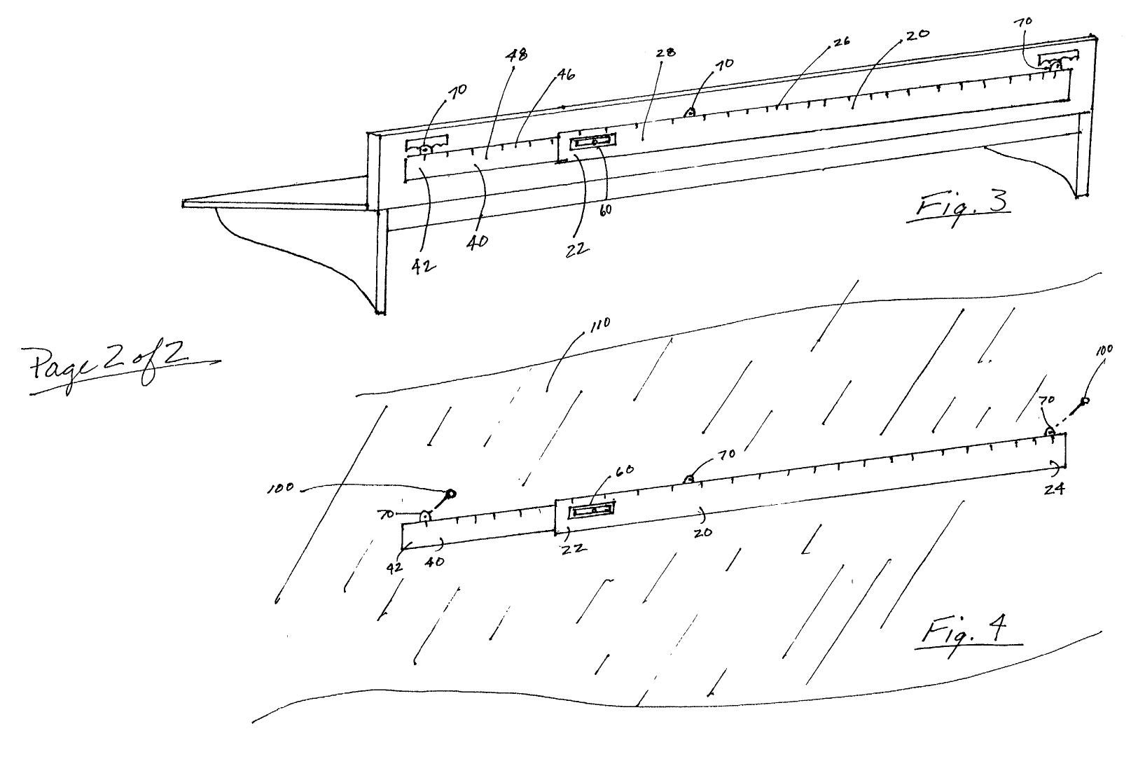

The invention, as shown in FIGS. 1-4 of the drawings, is a picture hanging slide ruler 10 for hanging items requiring two or more wall attachments 100 upon vertical planar surfaces 110, including walls in a level, appropriately spaced fashion, the invention comprising a fixed ruled sleeve member 20, a sliding ruled insert member 40, a level means 60 and two or more wall attachment locating tabs 70 having holes 72, at least one wall attachment locating tab 70 affixed to the fixed ruled sleeve member 20 and at least one wall attachment locating tab 70 affixed to the sliding ruled insert member 40.

The sliding ruled insert member 40 has a tabbed end 42 and an insert end 44, the sliding ruled insert member 40 provided with a ruled margin 46 on a surface 48 to indicate linear distance. The fixed ruled sleeve member 20, having an insertion end 22 and a closed end 24, is also provided with a ruled margin 46 on a surface 48 to indicate linear distance. The sliding ruled insert member 40 is contained within the fixed ruled sleeve member 20 in a slidable manner, with the insert end 44 of the sliding ruled insert member 40 inserted in the insertion end 22 of the fixed ruled sleeve member 20, with the respective ruled margins 26, 46 in a common visual plane, so that expanded distance may be determined using the combination of the respective ruled margins 26, 46. The level means 60, most preferably a bubble level device, is affixed to the surface 28 on the fixed ruled sleeve member 20 containing the ruled margin 26.

At least one wall attachment locating tab 70 is affixed to the sliding ruled insert member 40 at the tabbed end 42, and at least one wall attachment locating tab 70 is affixed to the fixed ruled sleeve member 20 at or near the closed end 24. These wall attachment locating tabs 70 may be slid apart in a linear direction, widening or narrowing the distance between them. A pencil or other marking device may be inserted through the holes 72 in the wall attachment locating tabs 70 to mark a wall 110 for the precision location for the wall attachments 100. In another embodiment, additional wall attachment locating tabs 70 may be provided which may be slidably engaged with the fixed ruled sleeve member 20 providing additional spaced locations for additional wall attachments 100, in the event more than two wall attachments 100 are required, as would be the case with curtains, tapestries, drapes, elongated shelves, garlands and ornamental trim.

Although the embodiments of the invention have been described and shown above, it will be appreciated by those skilled in the art that numerous modifications may be made therein without departing from the scope of the invention as herein described.

What is claimed is:

1. A picture hanging slide ruler for hanging items requiring two or more wall attachments upon vertical planar surfaces, including walls in a level, appropriately spaced fashion, the invention comprising:
a. a fixed ruled sleeve member;
b. a sliding ruled insert member;
c. a level means; and
d. two or more wall attachment locating tabs having holes, at least one wall attachment locating tab affixed to the fixed ruled sleeve member and at least one wall attachment locating tab affixed to the sliding ruled insert member.

2. The device as disclosed in claim 1, further comprising:
a. the sliding ruled insert member having a tabbed end, an insert end, and a ruled margin on a surface to indicate linear distance;
b. the fixed ruled sleeve member, having an insertion end, a closed end and a ruled margin on a surface to indicate linear distance, such sliding ruled insert member contained within the fixed ruled sleeve member in a slidable manner, with the insert end of the sliding ruled insert member inserted in the insertion end of the fixed ruled sleeve member, with the respective ruled margins in a common visual plane, so that expanded distance may be determined using the combination of the respective ruled margins;
c. the level means affixed to the surface on the fixed ruled sleeve member containing the ruled margin; and
d. a wall attachment locating tab affixed to the sliding ruled insert member at the tabbed end, and a wall attachment locating tab affixed to the fixed ruled sleeve member at or near the closed end, these wall attachment locating tabs slidable in a linear direction, widening or narrowing the distance between them, wherein a pencil or other marking device may be inserted through the holes in the wall attachment locating tabs to mark a wall for the precision location for the wall attachments.

3. The device as disclosed in claim 2, further including additional wall attachment locating tabs provided slidably engaged with the fixed ruled sleeve member providing additional spaced locations for additional wall attachments, in the event more than two wall attachments are required.
